(19) United States
(12) Patent Application Publication
(10) Pub. No.: US 2025/0156961 A1
(43) Pub. Date: May 15, 2025

(54) COMMUNITY-BASED ELECTRIC VEHICLES MARKETPLACE

(71) Applicants: Adebisi Adedokun, East Brunswick, NJ (US); Jerome Oglesby, Brentwood, TN (US)

(72) Inventors: Adebisi Adedokun, East Brunswick, NJ (US); Jerome Oglesby, Brentwood, TN (US)

(21) Appl. No.: 18/388,846

(22) Filed: Nov. 12, 2023

(51) Int. Cl. G06Q 50/00; G06Q 30/0251; G06Q 30/0645; G06Q 40/03

(52) U.S. Cl. CPC G06Q 50/01; G06Q 30/0255; G06Q 30/0645; G06Q 40/03

(57) ABSTRACT

This innovation merges two distinct concepts, creating a dynamic fusion of a peer-to-peer electric vehicle (EV) marketplace and a lending marketplace, all within a unique community-based social network. In this novel platform, lessors and lessees, as well as borrowers and lenders, engage socially to share various contents of interest, including the added feature of playing multiple games on the social network and responding to product advertisements relevant to their interests.

### BACKGROUND OF THE INVENTION

The present invention relates to an innovative fusion of an electric vehicle marketplace and a community-based social network. Specifically, it encompasses a unique platform that combines the functionalities of an electric vehicle marketplace and a social network to create a vibrant community of lessors and lessees of electric vehicles.

### FIELD OF THE INVENTION

The invention primarily pertains to the field of electric vehicle rentals and online marketplaces. It introduces a novel approach to connecting lessors and lessees while fostering a community-based social network environment.

### SUMMARY OF THE INVENTION

The invention, termed the “Community-based Electric Vehicles Marketplace,” is designed to address the need for a collaborative platform where lessors and lessees of electric vehicles can interact seamlessly. It combines the features of an electric vehicle marketplace with those of a social network to create a unique community where members can share various content related to electric vehicle rentals and other relevant interests.

### DESCRIPTION OF THE DRAWINGS

FIG. 1 shows a Blockchain Network Decentralized Application, which describes the processes and operations of the Community-based Electric Vehicles Marketplace.

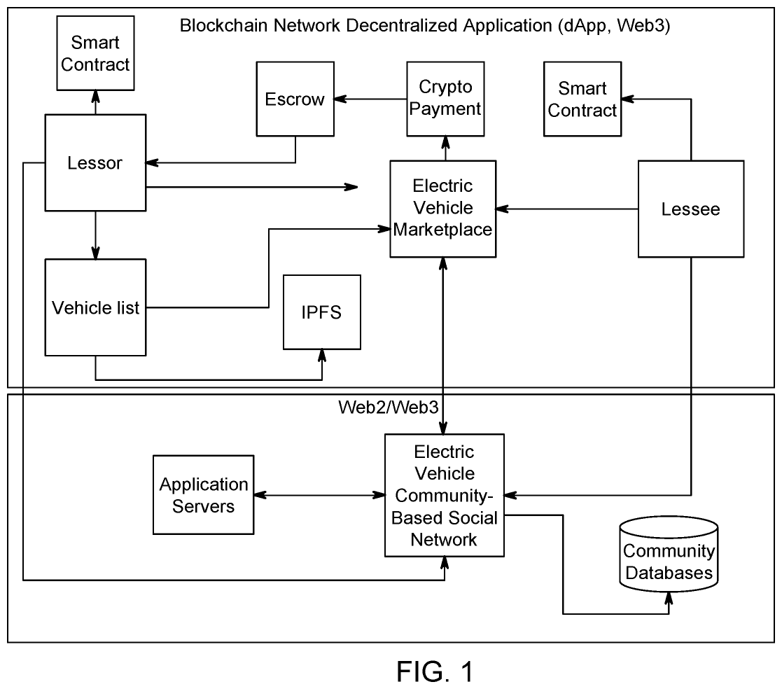

FIG. 2 shows the Electric Vehicle Marketplace Applications, which show and describe the applications relevant to the Community-based Electric Vehicles Marketplace.

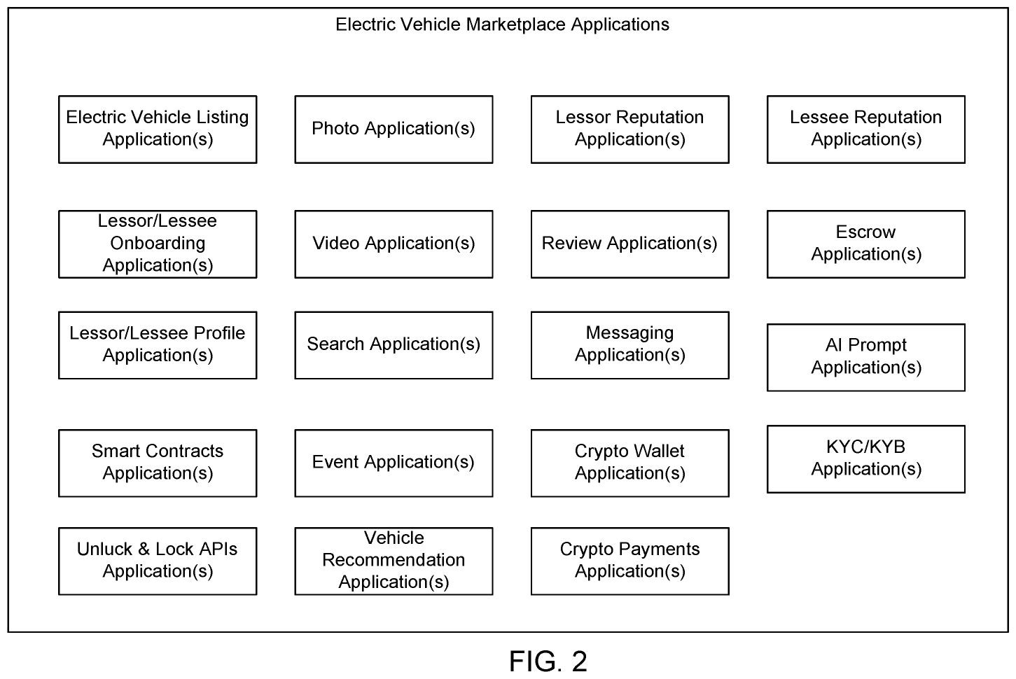

FIG. 3 shows the Electric Vehicle Community-Based Social Network Applications, which show and describe the social network applications relevant to the Community-based Electric Vehicles Marketplace.

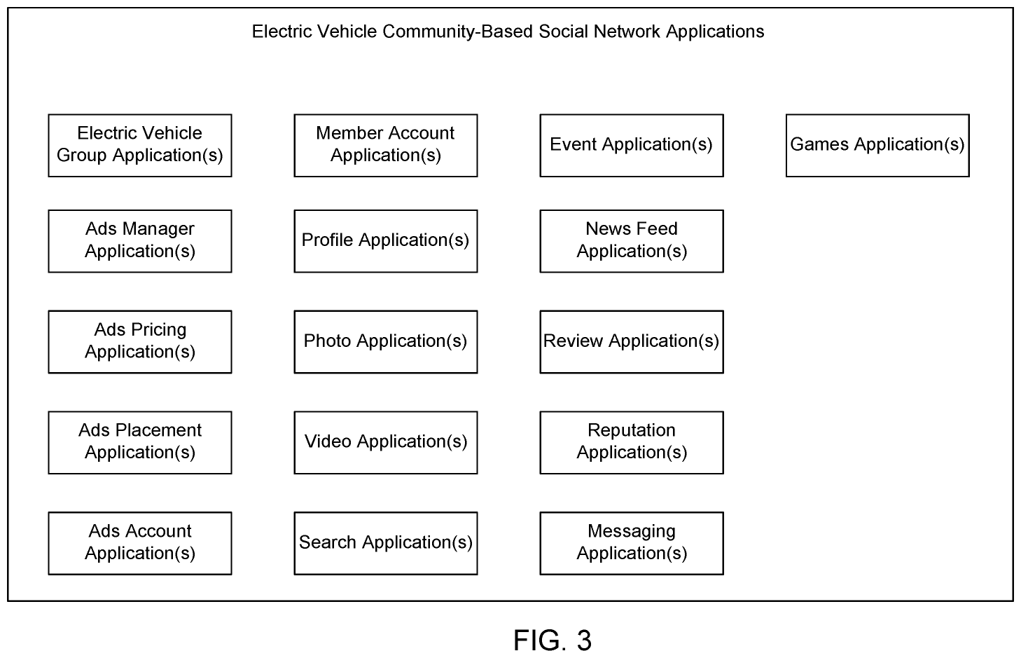

FIG. 4 shows a Blockchain Network Decentralized Finance, which describes the processes and operations of the Blockchain Lending Marketplace.

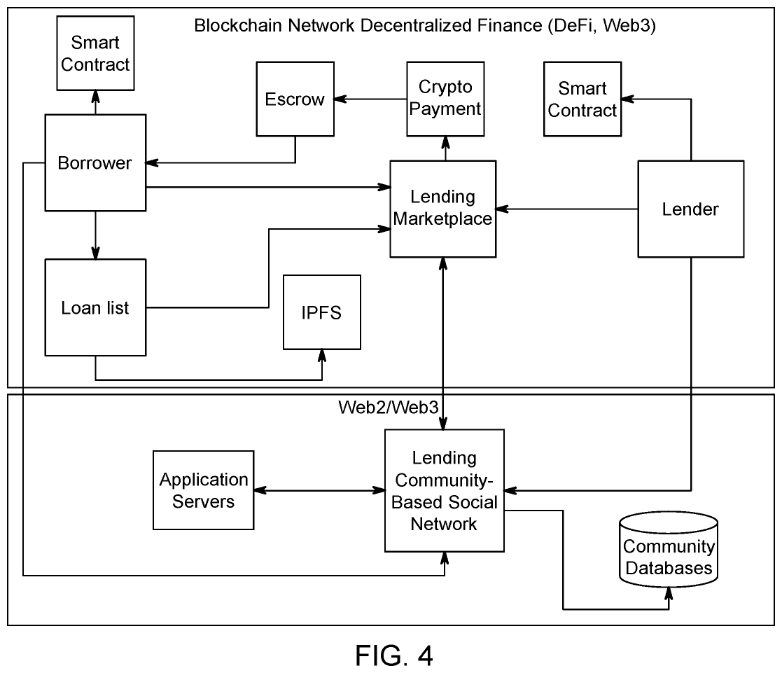

FIG. 5 shows the Blockchain Lending Marketplace Applications, which show and describe the applications relevant to the Blockchain Lending Marketplace.

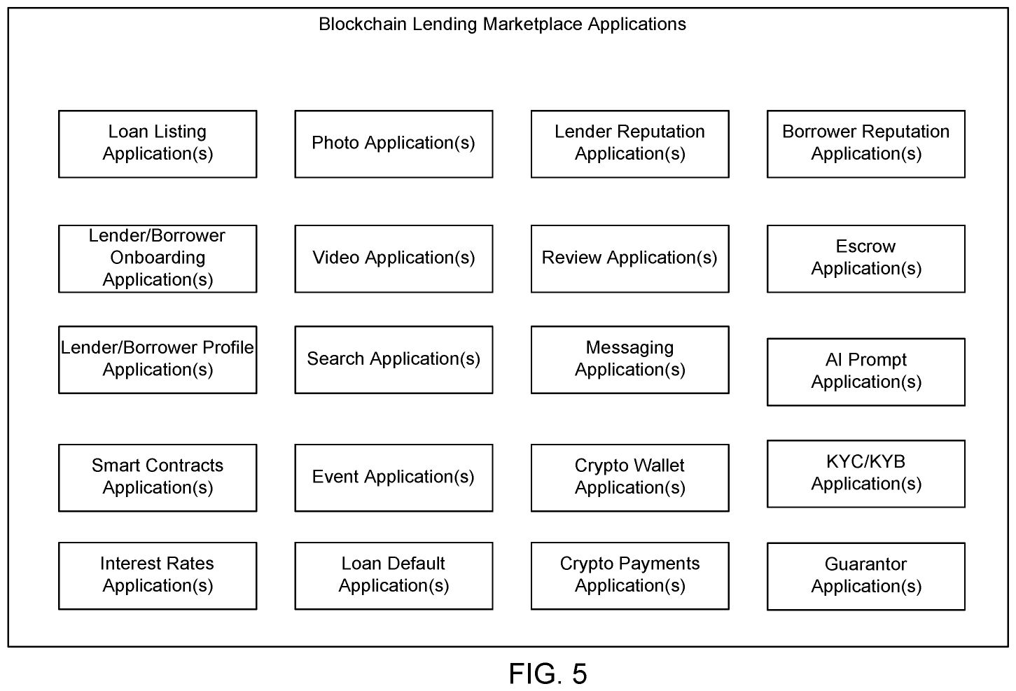

FIG. 6 shows the Blockchain Lending Marketplace Community-Based Social Network Applications, which show and describe the social network applications relevant to the Blockchain Lending Marketplace.

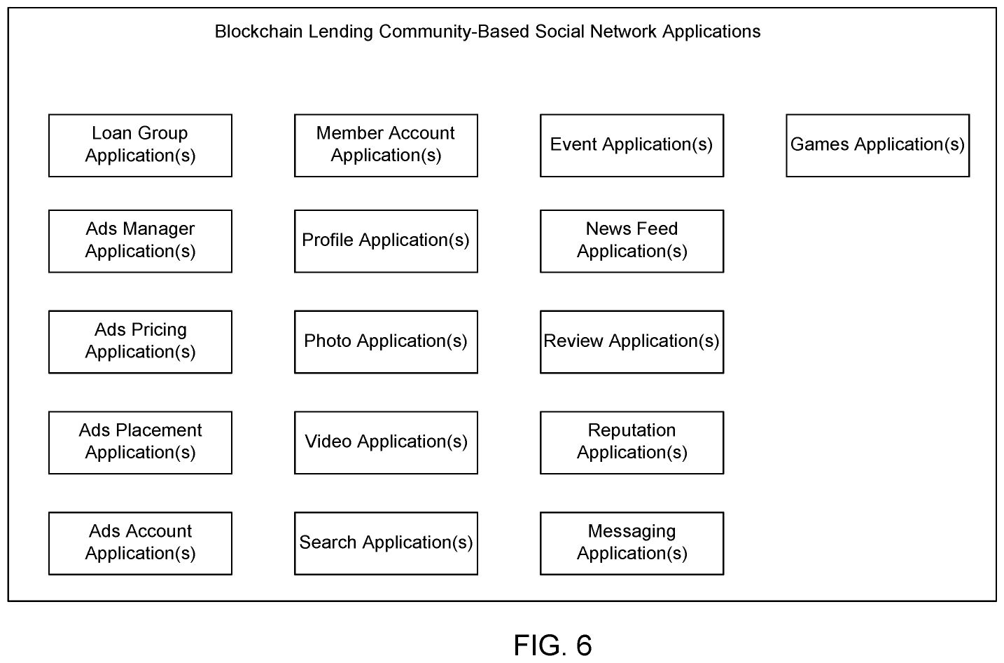

### DETAILED DESCRIPTION OF THE INVENTION

The Community-based Electric Vehicles Marketplace comprises two essential components: an electric vehicle marketplace and a community-based social network. These components are seamlessly integrated to provide a comprehensive platform for users.

The electric vehicle marketplace allows lessors to list their electric vehicles for rent. When a lessor adds a new electric vehicle to the marketplace, they are automatically added to a community associated with that specific vehicle model or category. This community-based approach ensures that relevant parties are connected and can collaborate effectively.

Lessees, on the other hand, can browse through the listings and, upon renting a vehicle, become part of the corresponding community. This integration happens automatically, and the community members are notified of the new addition. The community serves as a hub for communication, information sharing, and collaboration among lessees and lessors.

Within the community, members can share a wide range of content, including but not limited to: Accident information, Road conditions, Weather conditions, Videos, Safety information, and Traffic information.

This dynamic exchange of information enhances the overall experience of community members and fosters a sense of belonging. Additionally, the community network is designed to present relevant product advertisements to its members, potentially leading to beneficial purchasing opportunities.

One notable aspect of this invention is its ability to incorporate gamification elements within the community-based social network. Users can engage in various games and activities, further increasing their participation and interaction within the community.

In addition to the electric vehicle marketplace embodiment, the present invention also encompasses a community-based lending marketplace embodiment. This lending marketplace operates similarly to the electric vehicle marketplace but focuses on connecting lenders and borrowers within a community-based social network. Borrowers can list their borrowing requests, and lenders are automatically added to relevant lending communities based on loan categories. The lending community allows members to share information related to borrowing, lending, and other interests.

This innovation merges two distinct concepts, creating a dynamic fusion of a peer-to-peer lending marketplace and an electric vehicle (EV) marketplace, all within a unique community-based social network. In this novel platform, borrowers and lenders, as well as lessors and lessees, engage socially to share various contents of interest, including the added feature of playing multiple games on the social network.

Within the lending marketplace, a borrower introduces a new borrowing request, which is then appended to a list of loan requests. The borrower is seamlessly integrated into a community of borrowers categorized by loan type, such as Student, Personal, Auto, Mortgage, and more. This community structure facilitates notifications to all lenders associated with the specific loan category. Members within the lending community share an array of content, including borrowing information, interest rates, loan repayment details, videos, photos, and relevant product advertisements to enhance their collective experience. Notably, the addition of the gaming feature further bolsters community participation through gamification.

Similarly, in the EV marketplace, a lessor lists an electric vehicle for rental, thereby joining a community specific to that vehicle brand. All lessees associated with this community are promptly informed of the new addition. This shared network exchanges information on accidents, road conditions, weather conditions, safety recommendations, traffic updates, and more. Furthermore, relevant product advertisements are tailored to community members, catering to their specific interests and needs. As in the lending platform, the inclusion of multiple games fosters greater engagement and participation within the community.

The groundbreaking platform addresses a significant gap in the market, as no other solution combines a community-based social network with lending and electric vehicle marketplaces, enabling borrowers and lenders, as well as lessors and lessees, to interact, share, and collaborate on content of mutual interest. The gamification elements in the community network further enhance user engagement and the overall user experience.

1. A community-based electric vehicle marketplace, comprising:
an electric vehicle marketplace allowing lessors to list electric vehicles for rent;
a community-based social network automatically associating lessors with specific vehicle communities upon listing a vehicle;
a notification system alerting community members of new additions, including lessees who become part of a vehicle community upon renting; and
a content sharing platform within the community-based social network for sharing various content types related to electric vehicle rentals and other relevant interests.

2. The community-based electric vehicle marketplace of claim 1, further comprising a targeted advertisement system presenting product advertisements to community members based on their interests and interactions.

3. The community-based electric vehicle marketplace of claim 1, wherein the community-based social network incorporates gamification elements to enhance user engagement and participation.

4. A method for connecting lessors and lessees of electric vehicles in a community-based electric vehicle marketplace, comprising:
providing an electric vehicle marketplace for lessors to list electric vehicles for rent;
automatically associating lessors with specific vehicle communities upon listing a vehicle;
notifying community members of new additions, including lessees who become part of a vehicle community upon renting; and
facilitating the sharing of various content types related to electric vehicle rentals and other relevant interests within the community-based electric vehicle marketplace.

5. The method of claim 4, further comprising presenting targeted product advertisements to community members based on their interests and interactions.

6. The method of claim 4, wherein the community-based electric vehicle marketplace incorporates gamification elements to enhance user engagement and participation.

7. A community-based lending marketplace, comprising:
a lending marketplace allowing borrowers to list borrowing requests;
a community-based social network automatically associating borrowers with specific lending communities based on loan categories;
a notification system alerting community members of new borrowing requests, including lenders who become part of a lending community upon accepting a request; and
a content sharing platform within the community-based lending marketplace for sharing various content types related to borrowing, lending, and other relevant interests.

8. The community-based lending marketplace of claim 7, further comprising a targeted advertisement system presenting product advertisements to community members based on their interests and interactions.

9. The community-based lending marketplace of claim 7, wherein the community-based social network incorporates gamification elements to enhance user engagement and participation.
